(19) United States
(12) Patent Application Publication
(10) Pub. No.: US 2026/0078283 A1
(43) Pub. Date: Mar. 19, 2026

(54) ADHESIVE TAPE WITH AN ELECTRICALLY RELEASABLE ADHESIVE LAYER, ASSEMBLY, METHOD AND USE

(71) Applicant: tesa SE, Norderstedt (DE)

(72) Inventors: Klaus Keite-Telgenbüscher, Hamburg (DE); Shuang Wang, Hamburg (DE)

(73) Assignee: tesa SE, Norderstedt (DE)

(21) Appl. No.: 19/324,875

(22) Filed: Sep. 10, 2025

(30) Foreign Application Priority Data
Sep. 19, 2024 (EP) 24201238.3

(51) Int. Cl. C09J 9/02; B32B 7/12; B32B 37/12; B32B 43/00; C09J 7/38; C09J 11/00

(52) U.S. Cl. CPC C09J 9/02; B32B 7/12; B32B 37/1207; B32B 43/006; C09J 7/385; C09J 11/00; B32B 2037/1215; B32B 2307/7376; B32B 2405/00

(57) ABSTRACT

An adhesive tape comprising a plurality of interconnected layers is described. A first layer of the plurality of layers is an electrically releasable adhesive layer and has a first thickness. At least one second layer of the plurality of layers is provided, and each second layer is an electrically conductive carrier layer with a second thickness. At least one third layer of the plurality of layers is provided, and each third layer is an adhesive layer and has a third thickness. A ratio of the sum of the first thickness and each second thickness to the sum of each third thickness is equal to or less than 1.0. In addition, an assembly, a method and a use are represented and described.

### CROSS-REFERENCE TO RELATED APPLICATION

This application claims the benefit of priority under 35 U.S.C. § 119(b) of European Patent Application No. 24201238.3, entitled ADHESIVE TAPE WITH AN ELECTRICALLY RELEASABLE ADHESIVE LAYER, ASSEMBLY, METHOD AND USE, filed 19 Sep. 2024, the contents of which is relied upon and incorporated herein by reference in its entirety.

### FIELD OF THE DISCLOSURE

The disclosure relates to an adhesive tape with an electrically releasable adhesive layer, an assembly, a method and a use.

### BACKGROUND OF THE DISCLOSURE

Adhesive tapes with an electrically releasable adhesive layer are known from the prior art. These adhesive tapes have at least one electrically releasable adhesive layer whose peel adhesion can be reduced by applying an electrical voltage.

In general, it is desirable to provide adhesive tapes having an electrically releasable adhesive layer which are particularly robust mechanically and in particular have high impact strength.

It is therefore the object of the present disclosure to provide adhesive tapes having an electrically releasable adhesive layer which are particularly robust mechanically and in particular have high impact strength. This is a complex object, since each constituent of an adhesive tape naturally has an influence on the mechanical robustness.

### SUMMARY

According to a first aspect of the disclosure, the stated object is achieved by an adhesive tape with a plurality of interconnected layers. A first layer of the plurality of layers is an electrically releasable adhesive layer and has a first thickness measured perpendicular to an extent plane of the first layer. At least one second layer of the plurality of layers is provided. Each second layer is an electrically conductive carrier layer and has a second thickness measured perpendicular to an extent plane of the corresponding second layer. In addition, at least one third layer of the plurality of layers is provided. Every third layer is an adhesive layer and has a third thickness measured perpendicular to an extent plane of the corresponding third layer. A ratio of the sum of the first thickness and each second thickness to the sum of each third thickness is equal to or less than 1.0.

As already described, the adhesive tape comprises the plurality of interconnected layers. Preferably, the adhesive tape has a carrier layer which is connected to a first adhesive layer on a first side of the carrier layer and is connected to a second adhesive layer on a side of the carrier layer opposite the first side. Preferably, the first adhesive layer is the electrically releasable adhesive layer of the abovementioned first layer, and the second adhesive layer is the adhesive layer of a third layer of the abovementioned at least one third layer. Preferably, the adhesive tape has two carrier layers, each of which is connected to a first adhesive layer on a first side of the corresponding carrier layer and is connected to a second adhesive layer on a side of the corresponding carrier layer opposite the first side. Preferably, the first adhesive layer is the electrically releasable adhesive layer of the abovementioned first layer, and the second adhesive layer is the adhesive layer of a corresponding third layer of the abovementioned at least one third layer.

The abovementioned plurality of layers includes the first layer. Preferably, only one first layer is provided. The first layer is the electrically releasable adhesive layer. By means of the electrically releasable adhesive layer, the peel adhesion of the electrically releasable adhesive layer can be reduced by applying an electrical voltage. When in connection with the present disclosure an electrical voltage is applied and by means of the electrical voltage the peel adhesion of the electrically releasable adhesive layer or an electrically releasable adhesive layer is reduced, the electrical voltage is preferably applied to the adhesive tape such that the electrical voltage is applied at least portionally to the corresponding electrically releasable adhesive layer, so that at least a portion of the corresponding electrically releasable adhesive layer is exposed to the electrical voltage or to at least a fraction of the electrical voltage. Preferably, in a connected state of the adhesive tape, the electrically releasable adhesive layer, so that at least a portion of the corresponding electrically releasable adhesive layer is exposed to the electrical voltage or to at least a fraction of the electrical voltage. Preferably, in a connected state of the adhesive tape, the electrically releasable adhesive layer on a first side of the electrically releasable adhesive layer is connected to a second layer, which is an electrically conductive carrier layer, and on a second side of the electrically releasable adhesive layer, opposite the first side, is connected to a further component, which either is a further second layer, which is likewise an electrically conductive carrier layer, or is a substrate. By applying the electrical voltage, in particular perpendicular to the extent plane of the electrically releasable adhesive layer, the adhesive tape can be brought into a released state, since the peel adhesion of the electrically releasable adhesive layer can be reduced by the applied electrical voltage and thus the connection between the electrically releasable adhesive layer and the second layer and/or the connection between the electrically releasable adhesive layer and the further component, which is either the further second layer or the substrate, can be undone or at least weakened.

The first layer has the first thickness measured perpendicular to the extent plane of the first layer. Thus, the first layer extends in the extent plane of the first layer. Preferably, the first layer is deformable and in an undeformed state extends in the extent plane. A length and a width of the first layer can be defined in the extent plane. The first thickness is defined by an extent of the first layer perpendicular to the extent plane. Because the first thickness is measured perpendicular to the extent plane of the first layer, it is understood that the first thickness is defined by an extent of the first layer perpendicular to the extent that defines the length of the first layer, and perpendicular to the extent that defines the width of the first layer.

The plurality of layers includes at least one second layer. Preferably, only one second layer is provided. This case can also be described such that the at least one second layer consists of one second layer. Alternatively preferably, only two second layers are provided. This case can also be described such that the at least one second layer consists of two second layers. Each second layer is an electrically conductive carrier layer. Because the carrier layer is made electrically conductive, the electrically releasable adhesive layer can be electrically contacted by means of the electrically conductive carrier layer, so that at least a portion of the voltage source can be connected to the electrically conductive carrier layer and the electrical voltage can be provided, so that the peel adhesion of the electrically releasable adhesive layer can be reduced. In particular, because the carrier layer is made electrically conductive, the electrically releasable adhesive layer on a first side of the electrically releasable adhesive layer can be electrically contacted by means of a first electrically conductive carrier layer and the electrically releasable adhesive layer on a second side of the electrically releasable adhesive layer can be electrically contacted by means of a second electrically conductive carrier layer, so that at least a first portion of the voltage source can be connected to the first electrically conductive carrier layer and a second portion of the voltage source can be connected to the second electrically conductive carrier layer, and the electrical voltage can be provided such that the peel adhesion of the electrically releasable adhesive layer can be reduced. In the context of the present disclosure, a layer is preferably considered to be “electrically conductive” if the electrical conductivity of the layer is greater than 105 S/m. Preferably, the electrically conductive carrier layer comprises a metal and/or a metal alloy. Preferably, the metal is selected from the group consisting of copper, nickel, zinc, tin, silver, gold, aluminum, iron and chromium. Very particularly preferably, the metal is selected from the group consisting of aluminum, copper and nickel. The metal alloy is preferably selected from the group consisting of metal alloys comprising copper, nickel, zinc, tin, silver, gold, aluminum, iron, and/or chromium.

The electrically conductive carrier layer preferably comprises a metal foil, preferably an aluminum foil, and/or an electrically conductive textile including at least one metal, preferably selected from the group consisting of copper and nickel, and/or one or more plies of at least one metal applied by vapor deposition, preferably selected from the group consisting of copper and aluminum, and/or at least one metal grid and/or a foil coated with metal by vapor deposition.

Foil carriers used are polymer films, which can be single-layer or else multi-layer, wherein a multi-layer construction can be accomplished by coextrusion, lamination by means of an adhesive or by extrusion coating. The polymer films may be produced from all common plastics used for film production, including illustratively but without restriction: polyethylene—in particular HDPE, MDPE, LDPE, LLDPE, or copolymers and block copolymers of ethylene; polypropylene—in particular oriented polypropylene (OPP) produced by mono- or biaxial stretching, where HOMO-PP, HECO-PP or rPP can be used as the polymer; ethylene- or propylene-based ionomers, MA-grafted polymers, cyclic olefin copolymers (COC), polyvinyl chloride (PVC), polyesters—in particular biaxially oriented polyethylene terephthalate (PET) and polyethylene naphthalate (PEN), ethylene-vinyl alcohol (EVOH), polyethylene-vinyl acetate (EVA), polyvinylidene chloride (PVDC), polyvinylidene fluoride (PVDF), polyacrylonitrile (PAN), polycarbonate (PC), polyamide (PA), cellulose acetate, polymethyl methacrylate (PMMA), polyvinyl alcohol, polyurethane (PU), polyether sulfone (PES), paper or polyimide (PI). The aforesaid illustrative polymers can be used as a 100% system, as a blend with one or more further of the aforesaid illustrative polymers or in combination with further additives such as, for example, fillers, foaming agents, antioxidants, lubricants, antiblocking agents, dyes and pigments.

The film can form a continuous or perforated layer and can be unfoamed or foamed. Preferably, the film is unfoamed to avoid splitting of the adhesive tape under load. The electrically conductive textile can also be referred to as a “conductive mesh”. The electrically conductive textile preferably comprises a textile fabric, for example one made of PET (polyethylene terephthalate), that is coated with a metal, for example with copper and/or nickel, this being how the electrical conductivity of the fabric is produced. Preferably, the metal or the metal alloy of each second layer is at least portionally on the first layer and thus on the electrically releasable adhesive layer, thus ensuring electrical contact between the metal or the metal alloy of each second layer and the first layer. This is advantageous particularly when the electrically conductive carrier layer of each second layer comprises an electrically conductive metal coating or plurality of electrically conductive metal coatings, such as, for example, an electrically conductive metal coating of a film coated with metal by vapor deposition or a plurality of electrically conductive metal coatings of a plurality of films coated with metal by vapor deposition, or a plurality of electrically conductive metal coatings of a plurality of textiles coated with metal by vapor deposition. Alternatively preferably, a further layer, in particular a layer for protecting the metal or the metal alloy from corrosion, having a thickness of 100 nm or less than 100 nm, is arranged between the metal or the metal alloy and each second layer. Each second layer has the second thickness measured perpendicular to the extent plane of the corresponding second layer. Each second layer therefore extends in a corresponding extent plane of the corresponding second layer. Preferably, each second layer is deformable and extends in an undeformed state in the extent plane. A length and a width of the corresponding second layer can be defined in the respective extent plane. The second thickness is defined by an extent of the corresponding second layer perpendicular to the extent plane. Because the second thickness is measured perpendicular to the extent plane of the second layer, it is understood that the second thickness is defined by an extent of the second layer perpendicular to the extent that defines the length of the second layer, and perpendicular to the extent that defines the width of the second layer. Preferably, the extent plane of the first layer and the extent plane of each second layer run parallel to each other in an undeformed state of the adhesive tape.

The plurality of layers additionally includes at least one third layer. Preferably, only one third layer is provided. This case can also be described such that the at least one third layer consists of one third layer. Alternatively preferably, only two third layers are provided. This case can also be described such that the at least one third layer consists of two third layers. Each third layer is an adhesive layer. By means of the adhesive layer, each third layer can be connected to another component, such as a first substrate or a second substrate, in such a way that, in a connected state, a peel adhesion is provided which keeps the corresponding third layer and the component connected to the corresponding third layer in the connected state. For example, if only one third layer is provided, the first layer may be connected to a first substrate and the third layer may be connected to a second substrate, so that the adhesive tape connects the first substrate to the second substrate. If, for example, only two third layers are provided, a first third layer may be connected to the first substrate and a second third layer may be connected to the second substrate, so that the adhesive tape connects the first substrate to the second substrate. By providing the electrical voltage and reducing the peel adhesion of the electrically releasable adhesive layer, the first substrate and the second substrate can then be released from each other. The targeted release of the first substrate and the second substrate from each other can also be referred to as “debonding-on-demand”. For example, therefore, the adhesive tape can simplify the repair and recycling of components that are connected to each other by means of the tape. Preferably, each third layer has an adhesive layer which is not electrically releasable. When an electrical voltage is applied to the electrically non-releasable adhesive layer, the peel adhesion of the electrically non-releasable adhesive layer is preferably not reduced.

Each third layer has the third thickness measured perpendicular to the extent plane of the corresponding third layer. Each third layer therefore extends in a corresponding extent plane of the corresponding third layer. Preferably, each third layer is deformable and extends in an undeformed state in the extent plane. A length and a width of the corresponding third layer can be defined in the respective extent plane. The third thickness is defined by an extent of the corresponding third layer perpendicular to the extent plane. Because the third thickness is measured perpendicular to the extent plane of the third layer, it is understood that the third thickness is defined by an extent of the third layer perpendicular to the extent that defines the length of the third layer, and perpendicular to the extent that defines the width of the third layer. Preferably, the extent plane of the first layer, the extent plane of each second layer, and the extent plane of each third layer run parallel to each other in an undeformed state of the adhesive tape.

An essential difference between the adhesive tape according to the disclosure and adhesive tapes known from the prior art is that the ratio of the sum of the first thickness and each second thickness to the sum of each third thickness is equal to or less than 1.0. It has emerged that when the ratio of the sum of the first thickness and each second thickness to the sum of each third thickness is equal to or less than 1.0, the impact strength of the adhesive tape can be influenced particularly well by changing the ratio. In particular, when the ratio of the sum of the first thickness and each second thickness to the sum of each third thickness is equal to or less than 1.0, the impact strength of the adhesive tape could be increased significantly compared to adhesive tapes where the ratio is greater than 1.0. With decreasing ratio, the impact strength of the adhesive tape can be increased particularly strongly. Because the ratio of the sum of the first thickness and each second thickness to the sum of each third thickness is equal to or less than 1.0, a mechanically particularly robust adhesive tape with an electrically releasable adhesive layer can be provided. This is surprising, since each constituent of an adhesive tape that has an influence on the mechanical robustness, thus including the electrically conductive carrier layer(s), must be included and at least three layers must be harmonized with each other in thickness. In particular, the inclusion of the carrier layer(s) leads in accordance with the disclosure to particularly thick or particularly thin adhesive layer thicknesses within an adhesive tape structure, which the skilled person would initially have rejected as unbalanced. In summary, then, it can be stated that a mechanically particularly robust adhesive tape with an electrically releasable adhesive layer can be provided by means of the present disclosure.

In one embodiment, the ratio is greater than 0.1. Because the ratio is greater than 0.1, the electrical releasability of the electrically releasable adhesive layer of the first layer and the electrical conductivity of the electrically conductive carrier layer of the second layer can be ensured particularly reliably. Preferably, the ratio is greater than 0.1 and equal to or less than 1.0. A ratio greater than 0.1 and equal to or less than 1.0 has ensured particularly high impact strength of the adhesive tape and at the same time has particularly reliably ensured the electrical releasability of the electrically releasable adhesive layer of the first layer and the electrical conductivity of the electrically conductive carrier layer of the second layer. Particularly preferably, the ratio is greater than 0.25 and equal to or less than 0.95. A ratio greater than 0.25 and equal to or less than 0.95 has ensured particularly high impact strength of the adhesive tape and at the same time has even more reliably ensured the electrical releasability of the electrically releasable adhesive layer of the first layer and the electrical conductivity of the electrically conductive carrier layer of the second layer. A particularly high impact strength has been achieved at a ratio of equal to or less than 0.75.

The first and each third layer can be implemented fundamentally in a thickness of about 1 to about 2000 μm. The first layer preferably has a thickness in the range from 10 μm to 100 μm. The lower limit is preferred on account of the reliable electrical releasability, the upper limit for economic reasons, in order to keep low the volume of the layer, which is expensive owing to the required ingredients. A thickness of 10 to 30 μm is particularly preferred for the first layer. Each second layer can be implemented fundamentally in a thickness of about 0.05 to about 200 μm. Preferably, each second layer has a thickness in the range 1 to 30 μm to achieve on the one hand sufficient internal strength and on the other hand an advantageous flexibility.

In one embodiment, the plurality of interconnected layers consists of the first layer, a second layer and a third layer. If the plurality of interconnected layers consists of the first layer, the second layer and the third layer, then the first layer can be connected to a first substrate and the third layer can be connected to a second substrate, so that the adhesive tape connects the first substrate to the second substrate. If the plurality of interconnected layers consists of the first layer, the second layer and the third layer, a particularly simple adhesive tape structure is provided. Preferably, when the plurality of interconnected layers consist of the first layer, the second layer and the third layer, the plurality of interconnected layers are connected to each other such that the second layer is connected to the first layer on a first side of the second layer and the second layer is connected to the third layer on a second side of the second layer, opposite the first side.

In one embodiment, the plurality of interconnected layers consists of the first layer, two second layers and two third layers. If the plurality of interconnected layers consists of the first layer, two second layers and two third layers, then the first third layer can be connected to a first substrate and a second third layer can be connected to a second substrate, so that the adhesive tape connects the first substrate to the second substrate. If the plurality of interconnected layers consists of the first layer, two second layers and two third layers, the adhesive tape can be adapted particularly flexibly for certain applications, since, for example, the two third layers can be made identical or different. Preferably, when the plurality of interconnected layers consist of the first layer, two second layers and two third layers, the plurality of interconnected layers are connected to each other such that the first layer is connected to a first second layer of the two second layers on a first side of the first layer and the first layer is connected to a second second layer of the two second layers on a second side of the first layer, opposite the first side. In addition, preferably when the plurality of interconnected layers consist of the first layer, two second layers and two third layers, the plurality of interconnected layers are connected to each other such that the first second layer is connected to the first layer on a first side of the first second layer and the first second layer is connected to a first third layer of the two third layers on a second side of the first second layer, opposite the first side. In addition, preferably when the plurality of interconnected layers consist of the first layer, two second layers and two third layers, the plurality of interconnected layers are connected to each other such that the second second layer is connected to the first layer on a first side of the first second layer and the second second layer is connected to a second third layer of the two third layers on a second side of the second second layer, opposite the first side.

In one embodiment, the electrically releasable adhesive layer comprises an electrolyte. The advantage of the electrolyte is that the electrical releasability of the adhesive layer can be adjusted particularly easily.

In one embodiment, the electrolyte is selected from the group consisting of ionic liquids and metal salts. Ionic liquids and metal salts are particularly advantageous electrolytes.

Ionic liquids are preferred in the context of the present disclosure. They are salts that are liquid at a temperature of less than 100° C., especially at room temperature, i.e., 23° C. Ionic liquids accordingly comprise anions and cations. All ionic liquids are in principle suitable in the context of the present disclosure.

The anion of the ionic liquid is preferably selected from the group consisting of Br⁻, AlCl₄⁻, Al₂Cl₇⁻, NO₃⁻, BF₄⁻, PF₆⁻, CH₃COO⁻, CF₃COO⁻, CF₃CO₃⁻, CF₃SO₃⁻, (CF₃SO₂)₂N⁻, (CF₃SO₂)₃C⁻, AsF₆⁻, SbF₆⁻, CF₃(CF₂)₃SO₃⁻ (CF₃CF₂SO₂)₂N⁻, CF₃CF₂CF₂COO⁻, (FSO₂)₂N⁻. The anion is particularly preferably selected from the group consisting of (CF₃SO₂)₂N⁻ and (FSO₂)₂N⁻. Preferably, the cation of the ionic liquid is selected from the group consisting of imidazolium-based cations, pyridinium-based cations, pyrrolidine-based cations, and ammonium-based cations. Particularly preferably, the cation is selected from the group consisting of imidazolium-based cations.

Very particularly preferably, the cation is selected from the group consisting of 1-ethyl-3-methylimidazolium and 1-butyl-3-methylimidazolium. Even more preferably, the cation is 1-ethyl-3-methylimidazolium.

The electrolyte is particularly preferably selected from the group consisting of the ionic liquids 1-ethyl-3-methylimidazolium bis(trifluoromethylsulfonyl)imide (EMIM-TFSI) and 1-ethyl-3-methylimidazolium bis(fluorosulfonyl)imide (EMIM-FSI).

Examples of metal salts that may be contained in the electrically releasable adhesive layer include ammonium, alkali metal, alkaline earth metal or rare earth metal salts of perchlorate, tetrafluoroborate, hexafluorotitanate, hexafluorophosphate, hexafluoroantimonate, trifluoromethanesulfonimide, trifluoromethanesulfonate and bis(trifluoromethanesulfonyl)imide anions; and salts of organic acids, examples being lithium, sodium or potassium salts of aliphatic C₂ to C₆ mono- or di-carboxylic acids, and aromatic mono- or di-carboxylic acids; and ammonium or sodium salts of polyoxyethylene diphenyl ether sulfate, such as sodium laureth sulfate (SLES), for example; and mixtures of these salts. Preferred metal salts include lithium bis(trifluoromethylsulfonyl)imide, lithium perchlorate, sodium perchlorate, sodium hexafluorotitanate, and sodium laureth sulfate.

In one embodiment, the electrically releasable adhesive layer comprises a heat-activatable adhesive. Because the electrically releasable adhesive layer comprises the heat-activatable adhesive, the electrically releasable adhesive layer can provide a particularly high bond strength after activation, so that particularly large peel adhesion forces can be provided. Preferably, the heat-activatable adhesive is a physically heat-activatable adhesive. Alternatively preferably, the heat-activatable adhesive is a reactive heat-activatable adhesive. If the heat-activatable adhesive is a physically heat-activatable adhesive, the adhesive can also be referred to as a “hotmelt adhesive”. The physically heat-activatable adhesive is preferably not self-adhesive or slightly self-adhesive at room temperature.

Preferably, the adhesive compound is activated only with heat supply and in that case self-adhesive. Preferably, the activation temperature to achieve a sufficient tack—usually a few tens to a hundred degrees Celsius—is above room temperature. Preferably, owing to the self-adhesive properties, an adhesive effect occurs even before the adhesive has set. Preferably, after the joining of the adherends, the physically heat-activatable adhesive sets physically during cooling with solidification, so that the adhesive effect is maintained in the cooled state and has developed the actual peel adhesion forces there. Preferably, the connection of two materials to be bonded becomes stronger the more heat, pressure and/or time is applied during the bonding. By means of physically heat-activatable adhesives, particularly high bond strengths can be realized under technically easy processing conditions. The physical melting results in a high bond strength and thus adhesive effect. Preferably, the adhesives are purely physically heat-activatable adhesives. If the heat-activatable adhesive is a reactive heat-activatable adhesive, the heat-activatable adhesive can also be referred to as a “reactive adhesive”. Preferably, the reactive heat-activatable adhesive is a polymer system which has functional groups such that a chemical reaction takes place when heat is supplied, wherein the adhesive sets chemically, which causes a higher internal strength. It may likewise be advantageous to design the reactive adhesives in such a way that they become softer and/or more fluid at elevated temperature in order to optimally conform geometrically to the adhesive bond; this is achieved, in particular and preferably, by a thermoplastic component. Owing to the stated chemical reaction and also the physical melting, a high bond strength and thus adhesive effect is achieved.

Preferably, the electrically releasable first adhesive layer or the electrically releasable adhesive layer of the first layer comprises an activatable adhesive. By means of activatable adhesives, the layer can be made particularly thin, especially since activatable adhesives achieve a higher adhesive strength than pressure-sensitive adhesives. Furthermore, activatable adhesives, especially after activation, have a higher storage modulus G′ than pressure-sensitive adhesives. This reduces the risk of an electrical short circuit in the layer structure or during bonding, which can occur due to deformation of the electrically conductive carrier material when cutting or punching a section of adhesive tape, given the low ratios in accordance with the disclosure. Preferably, the electrically releasable first adhesive layer or the electrically releasable adhesive layer of the first layer comprises a thermally activatable adhesive (reactive adhesive). Preferably, the electrically releasable first adhesive layer or the electrically releasable adhesive layer of the first layer comprises a pressure-sensitive adhesive. Preferably, the electrically releasable first adhesive layer or the electrically releasable adhesive layer of the first layer comprises an activatable pressure-sensitive adhesive.

In one embodiment, the first layer comprises a pressure-sensitive adhesive and has a foamed electrically releasable first adhesive layer. This means that the electrically releasable adhesive layer is foamed. The foaming can be produced by means of microballoons. “Microballoons” are understood as meaning hollow microbeads that are elastic and hence expandable in their ground state and have a thermoplastic polymer shell. These beads have been filled with low-boiling liquids or liquefied gas. Shell material employed is especially polyacrylonitrile, PVDC, PVC or polyacrylates. Suitable low-boiling liquids or gas are in particular hydrocarbons of the lower alkanes, for example isobutane or isopentane, that are enclosed in the polymer shell under pressure in the form of liquefied gas, isopentane being particularly preferred. An action on the microballoons, particularly through the action of heat, results in softening of the outer polymer shell. At the same time, the liquid propellant gas present within the shell passes into its gaseous state. This causes irreversible extension and three-dimensional expansion of the microballoons. The expansion has ended when the internal and external pressures are equalized. Since the polymer shell is conserved, what is achieved is thus a closed-cell foam.

A multitude of microballoon types are commercially available, which differ essentially in their size (diameter 6 to 45 μm in the unexpanded state) and the starting temperatures that they require for expansion (75 to 220° C.). An example of commercially available microballoons is the Expancel® DU types (DU=dry unexpanded) from Nuryon and the Microsphere® FN types from Matsumoto.

In an alternative embodiment, the electrically releasable adhesive layer is not foamed, since it can then more easily be made very thin and the ratio according to the disclosure can be achieved more easily.

Preferably, each third layer comprises an adhesive layer which is not electrically releasable, so that when an electrical voltage is applied to the electrically non-releasable adhesive layer, the peel adhesion of the electrically non-releasable adhesive layer is preferably not reduced. Preferably, each third layer comprises a pressure-sensitive adhesive and/or a foamed adhesive layer. This means that the adhesive layer of the third layer is foamed. The foaming can be produced by means of microballoons. Particularly preferably, each third layer comprises a foamed adhesive layer which is electrically non-releasable. Preferably, the adhesive layer of each third layer comprises a pressure-sensitive adhesive. Preferably, the adhesive layer of each third layer comprises an activatable adhesive, in particular a thermally activatable adhesive (reactive adhesive). Preferably, the adhesive layer of each third layer comprises an activatable adhesive. Preferably, the adhesive layer of a first third layer comprises a pressure-sensitive adhesive, and the adhesive layer of a second third layer comprises an activatable adhesive, in particular a thermally activatable adhesive (reactive adhesive). Preferably, the adhesive layer of a first third layer comprises a pressure-sensitive adhesive, and the adhesive layer of a second third layer comprises an activatable pressure-sensitive adhesive. Preferably, the adhesive layer of a first third layer comprises an activatable adhesive, in particular a thermally activatable adhesive (reactive adhesive), and the adhesive layer of a second third layer comprises a pressure-sensitive adhesive. Preferably, the adhesive layer of a first third layer comprises an activatable adhesive, in particular a thermally activatable adhesive (reactive adhesive), and the adhesive layer of a second third layer comprises an activatable pressure-sensitive adhesive. Preferably, the adhesive layer of a first third layer comprises an activatable pressure-sensitive adhesive, and the adhesive layer of a second third layer comprises a pressure-sensitive adhesive. Preferably, the adhesive layer of a first third layer comprises an activatable pressure-sensitive adhesive, and the adhesive layer of a second third layer comprises an activatable adhesive, in particular a thermally activatable adhesive (reactive adhesive). Preferably, each third layer comprises an adhesive layer which is electrically releasable, so that when an electrical voltage is applied to the electrically releasable adhesive layer, the peel adhesion of the electrically releasable adhesive layer is reduced. Preferably, a first third layer comprises an adhesive layer which is electrically releasable, and a second third layer comprises an adhesive layer which is not electrically releasable. Preferably, a first third layer comprises an adhesive layer which is not electrically releasable, and a second third layer comprises an adhesive layer which is electrically releasable.

Preferably, the electrically releasable first adhesive layer or the electrically releasable adhesive layer of the first layer comprises an adhesive which, prior to a possible activation, has a higher storage modulus G′ than the storage modulus of each third layer, wherein each third layer preferably comprises an adhesive layer which is not electrically releasable, so that when an electrical voltage is applied to the electrically non-releasable adhesive layer, the peel adhesion of the electrically non-releasable adhesive layer is preferably not reduced. Particularly preferably, the storage modulus of the electrically releasable adhesive layer of the first layer is more than twice as high as the storage modulus of the adhesive layer of each third layer. In a preferred configuration, the storage modulus of the electrically releasable adhesive layer of the first layer is above 0.1 MPa, particularly preferably above 1 MPa, very particularly preferably above 5 MPa.

According to a second aspect of the disclosure, the stated object is achieved by an assembly comprising an adhesive tape according to the first aspect of the disclosure. In addition, the assembly comprises a first substrate and a second substrate. The first layer of the adhesive tape is connected to the first substrate and a third layer of the at least one third layer of the adhesive tape is connected to the second substrate. Alternatively, a third layer of the at least one third layer of the adhesive tape is connected to the first substrate and a further third layer of the at least one third layer of the adhesive tape is connected to the second substrate. The features, technical effects and/or advantages described in connection with the adhesive tape according to the first aspect of the disclosure apply at least in an analogous manner to the assembly according to the second aspect of the disclosure, and so a corresponding repetition is omitted at this point.

According to a third aspect of the disclosure, the stated object is achieved by a method intended for electrically releasing the assembly according to the second aspect of the disclosure. The method comprises the following steps: contacting a first portion of the assembly with a first portion of a voltage source and contacting a second portion of the assembly with a second portion of the voltage source and providing an electrical voltage using the voltage source, so that the electrical voltage is applied between the first portion of the assembly and the second portion of the assembly. If the plurality of interconnected layers consists of the first layer, the second layer and the third layer, the first portion of the assembly is preferably a portion of the first substrate of the assembly and the second portion of the assembly is preferably a portion of the second layer of the adhesive tape. If the plurality of interconnected layers consist of the first layer, two second layers and two third layers, the first portion of the assembly is preferably a portion of one of the two second layers of the adhesive tape, and the second portion of the assembly is preferably a portion of the other of the two second layers of the adhesive tape. The features, technical effects and/or advantages described in the context of the adhesive tape according to the first aspect of the disclosure and the features, technical effects and/or advantages described in the context of the assembly according to the second aspect of the disclosure also apply at least in an analogous manner to the method according to the third aspect of the disclosure, and so a corresponding repetition is omitted at this point.

According to a fourth aspect of the disclosure, the stated object is achieved by a use of an adhesive tape according to the first aspect of the disclosure, where the use is intended for bonding components of electrical or electronic devices, motor vehicles or medical devices. Preferably, the abovementioned first substrate forms a first portion of the electrical or electronic device, the motor vehicle or the medical device, and the abovementioned second substrate forms a second portion of the electrical or electronic device, the motor vehicle or the medical device. The features, technical effects and/or advantages described in connection with the adhesive tape according to the first aspect of the disclosure, the features, technical effects and/or advantages described in connection with the assembly according to the second aspect of the disclosure, and the features, technical effects and/or advantages described in connection with the method according to the third aspect of the disclosure also apply at least in an analogous manner to the use according to the fourth aspect of the disclosure, and so a corresponding repetition is omitted at this point.

Although the method steps are described in one certain order, the present disclosure is not limited to this order. Rather, the individual method steps can be carried out in any meaningful order, including in particular at least in portions temporally in parallel with each other.

Further features, advantages and application possibilities of the present disclosure are evident from the following description of the working examples and the figures. In this description, all the described and/or pictured features, in themselves and in any combination, form the subject matter of the disclosure regardless of their composition in the individual claims or their dependency references. The figures continue to contain the same reference signs for the same or similar objects.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the disclosure and the appended claims.

The accompanying drawings are included to provide a further understanding and are incorporated in and constitute a part of this specification. The drawings illustrate one or more embodiments and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

In the following detailed description, for purposes of explanation and not limitation, example embodiments disclosing specific details are set forth to provide a thorough understanding of various principles of the release liner of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

In the Drawings:

FIG. 1 shows a schematic representation of a first embodiment of an adhesive tape according to the disclosure,

FIG. 2 shows a schematic representation of a first embodiment of an adhesive tape according to the disclosure,

FIG. 3 shows a schematic representation of a first embodiment of an assembly according to the disclosure,

FIG. 4 shows a schematic representation of a second embodiment of the assembly according to the disclosure,

FIG. 5 shows a schematic representation of an embodiment of a method according to the disclosure for electrically releasing the assembly according to the disclosure, and

FIG. 6 shows a scatter diagram in which the impact strength is plotted against the ratio for different examples of adhesive tapes.

### DETAILED DESCRIPTION

In the following detailed description, for purposes of explanation and not limitation, example embodiments disclosing specific details are set forth to provide a thorough understanding of various principles of the adhesive tape of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or description that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

As used herein, the singular forms “a,” “an,” and “the” include plural referents unless the context clearly dictates otherwise. Thus, for example, reference to a “component” includes aspects having two or more such components, unless the context clearly indicates otherwise.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

The disclosure, moreover, embraces all the features which are subjects of any dependent claims. Further, the disclosure embraces combinations of individual features with one another, including at different preference levels. The disclosure thus embraces, for example, the combination of a first feature identified as being “preferred” with a second feature identified as being “particularly preferred”. In this context, subjects identified as part of “embodiments”, likewise at different preference levels, are also embraced.

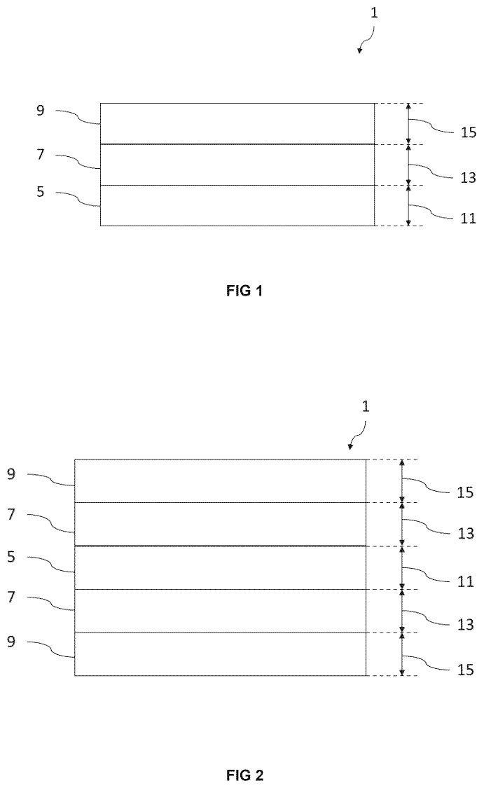

The first embodiment of the adhesive tape 1 according to the disclosure as represented in FIG. 1 and the second embodiment of the adhesive tape 1 according to the disclosure as represented in FIG. 2 have a plurality of interconnected layers. Each layer of the interconnected layers extends along a corresponding extent plane perpendicular to the image plane of FIGS. 1 and 2.

A first layer 5 of the plurality of layers is an electrically releasable adhesive layer. In addition, at least one second layer 7 of the plurality of layers is provided, with each second layer 7 being an electrically conductive carrier layer. In addition, at least one third layer 9 of the plurality of layers is provided, with each third layer 9 being an adhesive layer. The first layer 5 has a first thickness 11 measured perpendicular to an extent plane of the first layer 5, each second layer 7 has a second thickness 13 measured perpendicular to an extent plane of the corresponding second layer 7, and each third layer 9 has a third thickness 15 measured perpendicular to an extent plane of the corresponding third layer 9.

Both in the first embodiment of the adhesive tape 1 according to the disclosure as represented in FIG. 1 and in the second embodiment of the adhesive tape 1 according to the disclosure as represented in FIG. 2, a ratio of the sum of the first thickness 11 and each second thickness 13 to the sum of each third thickness 15 is equal to or less than 1.0. It has emerged that when the ratio of the sum of the first thickness 11 and each second thickness 13 to the sum of each third thickness 15 is equal to or less than 1.0, the impact strength can be significantly increased. In particular, it has emerged that at a ratio of equal to or less than 1.0, a further reduction of the ratio leads to a further increase in the impact strength.

Preferably, the ratio is greater than 0.1. A ratio of greater than 0.1 ensures that the electrical releasability of the electrically releasable adhesive layer of the first layer and the electrical conductivity of the electrically conductive carrier layer of the second layer are particularly reliably ensured. Preferably, the ratio is greater than 0.1 and equal to or less than 1.0. A ratio greater than 0.1 and equal to or less than 1.0 has ensured particularly high impact strength of the adhesive tape and at the same time has particularly reliably ensured the electrical releasability of the electrically releasable adhesive layer of the first layer and the electrical conductivity of the electrically conductive carrier layer of the second layer. Particularly preferably, the ratio is greater than 0.25 and equal to or less than 0.95. A ratio greater than 0.25 and equal to or less than 0.95 has ensured particularly high impact strength of the adhesive tape and at the same time has even more reliably ensured the electrical releasability of the electrically releasable adhesive layer of the first layer and the electrical conductivity of the electrically conductive carrier layer of the second layer. A particularly high impact strength has been achieved at a ratio of equal to or less than 0.75.

In the first embodiment of the adhesive tape 1 of the disclosure as represented in FIG. 1, the several interlinked layers consist of the first layer 5, a second layer 7 and a third layer 9. The first embodiment of the adhesive tape 1 according to the disclosure as represented in FIG. 1 consists of the plurality of interconnected layers, which in turn consist of the first layer 5, the second layer 7 and the third layer 9.

In the second embodiment of the adhesive tape 1 according to the disclosure as represented in FIG. 2, the plurality of interconnected layers consist of the first layer 5, two second layers, namely a second layer 7 shown above the first layer 5 and a second layer 7 shown below the first layer 5, and two third layers 9, namely a third layer 9 shown above the first layer 5 and a third layer 9 shown below the first layer 5. The second embodiment of the adhesive tape 1 according to the disclosure, as represented in FIG. 2, consists of the plurality of interconnected layers, which in turn consist of the first layer 5, two second layers, namely a second layer 7 shown above the first layer 5 and a second layer 7 shown below the first layer 5, and two third layers, namely a third layer 9 shown above the first layer 5 and a third layer 9 shown below the first layer 5.

Both in the first embodiment of the adhesive tape 1 according to the disclosure as represented in FIG. 1 and in the second embodiment of the adhesive tape 1 according to the disclosure as represented in FIG. 2, the electrically releasable adhesive layer comprises an electrolyte. The electrolyte is an ionic liquid. In an alternative embodiment, the electrolyte is a metal salt. In addition, both in the first embodiment of the adhesive tape 1 according to the disclosure as represented in FIG. 1 and in the second embodiment of the adhesive tape 1 according to the disclosure as represented in FIG. 2, the electrically releasable adhesive layer comprises a heat-activatable adhesive.

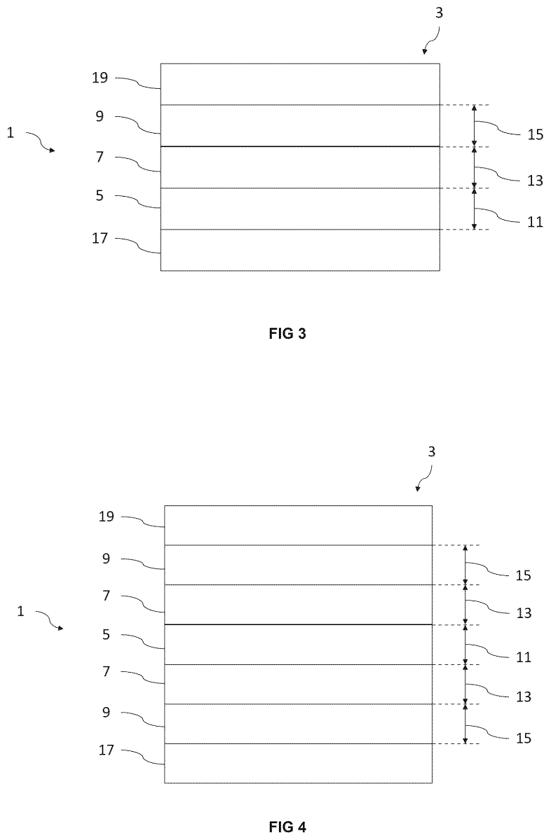

As already described, FIG. 3 shows the schematic representation of the first embodiment of the assembly 3 according to the disclosure, and FIG. 4 shows the schematic representation of the second embodiment of the assembly 3 according to the disclosure. The first embodiment of the assembly 3 according to the disclosure comprises the first embodiment of the adhesive tape 1 according to the disclosure, as represented schematically in FIG. 1. The second embodiment of the assembly 3 according to the disclosure comprises the second embodiment of the adhesive tape 1 according to the disclosure, as represented schematically in FIG. 2. Both the first embodiment of the assembly 3 according to the disclosure and the second embodiment of the assembly 3 according to the disclosure comprise a first substrate 17 and a second substrate 19. In the first embodiment of the assembly 3 according to the disclosure, as represented schematically in FIG. 3, the first layer 5 of the adhesive tape 1 is connected to the first substrate 17 and a third layer 9 of the at least one third layer 9 of the adhesive tape 1 is connected to the second substrate 19. In the second embodiment of the assembly 3 according to the disclosure, as represented schematically in FIG. 4, a third layer 9 of the at least one third layer 9 of the adhesive tape 1 is connected to the first substrate 17 and a further third layer 9 of the at least one third layer 9 of the adhesive tape 1 is connected to the second substrate 19. Within the assembly 3, therefore, the adhesive tape 1 connects the first substrate 17 to the second substrate 19. By provision of the electrical voltage, in particular between the second layer 7 and the substrate 17, and reduction of the peel adhesion of the electrically releasable adhesive layer, the first substrate 17 and the second substrate 19 can then be released from each other. The targeted release of the first substrate and the second substrate from each other can also be referred to as “debonding-on-demand”. For example, therefore, the adhesive tape can simplify the repair and recycling of components that are connected to each other by means of the tape.

As already described, FIG. 5 shows a schematic representation of an embodiment of the method according to the disclosure for electrically releasing the assembly 3 according to the disclosure. In a first method step 101, a first portion of the assembly 3 is contacted with a first portion of a voltage source. In addition, in the first method step 101, a second portion of the assembly 3 is contacted with a second portion of the voltage source. In a second method step 102, an electrical voltage is provided by means of the voltage source, so that the electrical voltage is applied between the first portion of the assembly and the second portion of the assembly. In a third method step 103, the first portion of the voltage source is removed from the first portion of the assembly 3. In addition, in the third method step 103, the second portion of the voltage source is removed from the second portion of the assembly 3. After the third method step 103, the voltage source can be used for the electrical release of another assembly 3. Because, in the second method step 102, an electrical voltage is provided by means of the voltage source, so that the electrical voltage is applied between the first portion of the assembly and the second portion of the assembly, the electrical voltage is at least partially also present at the first layer of the assembly 3 and thus at least partially at the electrically releasable adhesive layer, so that, by provision of the electrical voltage, the peel adhesion of the electrically releasable adhesive layer is reduced and thus the first portion of the assembly and the second portion of the assembly can be more easily released from each other. Compared to the situation in which no electrical voltage is provided, a comparatively low force must be applied to release the first portion of the assembly and the second portion of the assembly from each other. This force is preferably applied during the second method step 102, after the second method step 102 and before the third method step 103, during the third method step 103 or after the third method step 103, so that the first portion of the assembly and the second portion of the assembly are released from each other and hence separated preferably during the second method step 102, after the second method step 102 and before the third method step 103, during the third method step 103 or after the third method step 103.

A further aspect of the present disclosure is the use of any adhesive tape 1 already described for bonding components of electrical or electronic devices, motor vehicles or medical devices. Preferably, the abovementioned first substrate 17 forms a first portion of the electrical or electronic device, the motor vehicle or the medical device, and the abovementioned second substrate 19 forms a second portion of the electrical or electronic device, the motor vehicle or the medical device.

For the adhesive layer of each first layer 5 and for the adhesive layer of each third layer 9, a pressure-sensitive acrylate adhesive having the composition 47% by weight n-butyl acrylate, 30% by weight phenoxyethyl acrylate, 20% by weight methyl acrylate and 3% acrylic acid was polymerized. A 300 L reactor conventional for radical polymerizations was charged with a total of 100 kg of the monomers according to the specified composition and 72.4 kg of benzine/acetone (70:30). After nitrogen gas had been passed through it for 45 minutes with stirring, the reactor was heated to 58° C. and 50 g of Vazo® 67 were added. The jacket temperature was then heated to 75° C. and the reaction was carried out constantly at this external temperature. After 1 h reaction time, a further 50 g of Vazo® 67 were added. After 3 h, the reaction mixture was diluted with 20 kg of benzine/acetone (70:30) and after 6 h with 10.0 kg of benzine/acetone (70:30). To reduce the residual initiators, 0.15 g of Perkadox® 16 was added after 5.5 h and again after 7 h. The reaction was terminated after 24 h reaction time and the reaction mixture cooled to room temperature. The solution was adjusted to a solids content of 38% by weight. The average molecular weight is Mw=768 000 g/mol and the polydispersity is D (Mw/Mn)=8.8. In all examples, 0.2 part of aluminum chelate based on the fraction of acrylate is added for crosslinking.

As already described, the first layer 5 of the plurality of layers is an electrically releasable adhesive layer. In the context of the present disclosure, an electrically releasable adhesive layer is preferably to be understood as a layer of adhesive for which, when the adhesive layer is connected to another component, such as to a second layer 7 or to a plurality of second layers, and a peel adhesion is defined by this connection, this peel adhesion is greater than a peel adhesion threshold and, after an electrical voltage has been applied between a first portion of the adhesive layer and a second portion of the adhesive layer, the peel adhesion is less than the peel adhesion threshold. For examples described in detail later on, the electrically releasable adhesive layer may be embodied differently.

For the production of the electrically releasable adhesive layer of the first layer 5, according to a first working example of the electrically releasable adhesive layer of the first layer 5, 100 parts of the already described pressure-sensitive acrylate adhesive (calculated without solvent) were admixed with 7 parts of 1-ethyl-3-methylimidazolium bis(trifluoromethylsulfonyl)imide (EMIM-TFSI) and 3.5 parts of PEG400. The pressure-sensitive acrylate adhesive admixed with 7 parts of 1-ethyl-3-methylimidazolium bis(trifluoromethylsulfonyl)imide (EMIM-TFSI) and 3.5 parts of PEG400 was applied to a siliconized polyester film (release liner) and dried at 120° C. for 15 minutes. Each first thickness 11 corresponds to a layer thickness after drying. Each first layer has a modulus G′ of 0.06 MPa at 23° C. and 1 Hz.

For the production of the electrically releasable adhesive layer of the first layer 5, according to a second working example of the electrically releasable adhesive layer of the first layer 5, wherein the electrically releasable adhesive layer is an activatable adhesive layer, 87.0% by weight, based on the later total amount of the adhesive without solvent, of Desmomelt® 530 (polyurethane) was dissolved in MEK. Subsequently, 10.0% by weight of Dancure® 999 was added and intensively mixed with the dissolved polyurethane. Then 3.0% by weight of the ionic liquid 1-ethyl-3-methylimidazolium bis(trifluoromethylsulfonyl)imide (EMIM-TFSI) was added and likewise intensively mixed. The solution was adjusted to a solids content of 38% by weight. The dried adhesive layer, activated in a heating press at 100° C. for 5 min at a pressure of 1 MPa, has a modulus G′ of 1.7 MPa at 23° C. and 1 Hz.

For the production of the electrically releasable adhesive layer of the first layer 5, according to a third working example of the electrically releasable adhesive layer of the first layer 5, 100 parts of the already described pressure-sensitive acrylate adhesive (calculated without solvent) were admixed with 7 parts of 1-ethyl-3-methylimidazolium bis(trifluoromethylsulfonyl)imide (EMIM-TFSI), 3.5 parts of PEG400 and 0.75 part of Nouryon 920 DU 40 microballoons, and coated and dried like K1. Finally, the microballoons were expanded at a temperature of 150° C. for 2 min. Layers of different layer thickness were produced after drying and expansion. It has emerged that in the case of adhesive tapes in which the electrically releasable adhesive layer of the first layer 5 is embodied according to the third working example, substantially the same properties are achieved, in particular with regard to the impact strength, as in the case of adhesive tapes in which the electrically releasable adhesive layer of the first layer 5 is embodied according to the first working example. It can therefore be concluded in particular that in the case of adhesive tapes with electrically releasable adhesive layers, adjusting the ratio has a much greater influence on the impact strength and thus on the mechanical robustness of the adhesive tape than is the case, for example, with measures that are conventional/familiar to the skilled person for increasing the impact strength, such as foaming with microballoons. In particular, the influence of the microballoons on the impact strength is less than the influence of the targeted adjustment of the ratio both for ratios of equal to or less than 1.0 (see comparison of Examples 5 and 6 and comparison of Examples 8, 9 and 10) and for ratios of greater than 1.0 (see comparison of Examples 11 and 12, comparison of Examples 13, 14 and 15, and comparison of Examples 17 and 18). For example, the examples described in detail later on in Table 2 show that adjusting the ratio results in a change in the impact strength of several hundred mJ, and adding microballoons causes a change in the impact strength of less than a hundred mJ.

As already described, each second layer 7 is an electrically conductive carrier layer. For the examples described in detail later on, the electrically conductive carrier layer is embodied identically in each case. A 12 μm thick PET film from Hueck coated with aluminum on one side by vapor deposition was used; the optical density of the film with aluminum layer was about 1.9.

As already described, each third layer 9 is an adhesive layer. For the examples described in detail later on, the adhesive layer is embodied identically in each case. For the production of the adhesive layer of each third layer 9, 100 parts of the already described pressure-sensitive acrylate adhesive (calculated without solvent) were admixed with 0.75 part of Nouryon 920 DU 40 microballoons. The pressure-sensitive acrylate adhesive admixed with the microballoons was applied to a siliconized polyester film (release liner) and dried at 120° C. for 15 minutes. Finally, the microballoons were expanded at a temperature of 150° C. for two minutes. Each third thickness 15 corresponds to a layer thickness after drying and expansion of the microballoons. Each third layer 9 has a modulus G′ of 0.07 MPa at 23° C. and 1 Hz. The third layer 9 comprises an adhesive layer which is not electrically releasable.

The following table (Table 1) shows various materials used in connection with the present disclosure.

TABLE 1

| Designation used/ | | | |
|---|---|---|---|
| Trade name | Vendor | Specification | Function |
| EMIM-TFSI | Iolitec | 1-Ethyl-3-methylimidazolium | Electrolyte |
| | | bis(trifluoromethylsulfonyl)imide | component |
| 920 DU 40 | Nouryon | Expandable microballoons | Impact modifier |
| PEG 400 | Merck | Polyethylene glycol with | Electrolyte |
| | | Mw = 400 | component |
| Desmomelt ® 530 | Covestro AG, | Hydroxyl-terminated, largely | Polymer |
| | Leverkusen, | linear, thermoplastic, highly | component |
| | Germany | crystalline polyurethane | |
| | | elastomer | |
| Dancure ® 999 | Danquinsa GmbH | 2,4-Dioxo-1,3-diazetidine-1,3- | Crosslinker |
| | | bis(4-methyl-m-phenylene) | |
| | | diisocyanate | |
| MEK | Shell | Methyl ethyl ketone; | Solvent |
| | | CAS 78-93-3 | |

The following table (Table 2) lists ratios, impact strengths, number of layers, layer structure and thicknesses of the respective layers for illustrative adhesive tapes (shown by ascending ratio). In the layer structure column, (5)=electrically releasable adhesive layer—(a) with acrylate PSA (pressure-sensitive adhesive; see first working example), (b) with activatable adhesive layer (see second working example), (c) with acrylate PSA with microballoons (see third working example); (7)=electrically conductive carrier layer; and (9)=adhesive layer with acrylate PSA with microballoons; as already described in detail above.

TABLE 2

| | | | | | |
|---|---|---|---|---|---|
| | | DuPont | | | |
| | | Impact | Number | | Thickness |
| | | Strength | of | Layer | of the |
| Example | Ratio | (mJ) | layers | structure | layers (μm) |

Examples according to the disclosure

| | | | | | |
|---|---|---|---|---|---|
| 1 | 0.26 | 984 | 3 | 5(b)/7/9 | 15/12/105 |
| 2 | 0.34 | 902 | 5 | 9/7/5(b)/7/9 | 50/12/10/12/50 |
| 3 | 0.47 | 767 | 3 | 5(b)/7/9 | 30/12/90 |
| 4 | 0.49 | 909 | 5 | 9/7/5(a)/7/9 | 45/12/20/12/45 |
| 5 | 0.68 | 738 | 5 | 9/7/5(a)/7/9 | 40/12/30/12/40 |
| 6 | 0.68 | 768 | 5 | 9/7/5(c)/7/9 | 40/12/30/12/40 |
| 7 | 0.89 | 601 | 3 | 5(b)/7/9 | 50/12/70 |
| 8 | 0.91 | 712 | 5 | 9/7/5(b)/7/9 | 35/12/40/12/35 |
| 9 | 0.91 | 651 | 5 | 9/7/5(a)/7/9 | 35/12/40/12/35 |
| 10 | 0.91 | 629 | 5 | 9/7/5(c)/7/9 | 35/12/40/12/35 |

Examples not according to the disclosure

| | | | | | |
|---|---|---|---|---|---|
| 11 | 1.20 | 532 | 3 | 5(c)/7/9 | 60/12/60 |
| 12 | 1.20 | 521 | 3 | 5(b)/7/9 | 60/12/60 |
| 13 | 1.23 | 503 | 5 | 9/7/5(c)/7/9 | 30/12/50/12/30 |
| 14 | 1.23 | 470 | 5 | 9/7/5(b)/7/9 | 30/12/50/12/30 |
| 15 | 1.23 | 521 | 5 | 9/7/5(a)/7/9 | 30/12/50/12/30 |
| 16 | 1.64 | 493 | 3 | 5(c)/7/9 | 70/12/50 |
| 17 | 1.68 | 508 | 5 | 9/7/5(c)/7/9 | 25/12/60/12/25 |
| 18 | 1.68 | 502 | 5 | 9/7/5(a)/7/9 | 25/12/60/12/25 |
| 19 | 2.35 | 487 | 5 | 9/7/5(a)/7/9 | 20/12/70/12/20 |

Examples 1 to 19 are addressed in detail below. Since the ratio for Examples 1 to 10 is equal to or less than 1.0, Examples 1 to 10 can also be referred to as examples according to the disclosure. Since the ratio for Examples 11 to 19 is greater than 1.0, Examples 11 to 19 can also be referred to as examples not according to the disclosure.

### Example 1

Example 1 of the adhesive tape 1 shown in Table 2 corresponds to the first embodiment of the adhesive tape 1 according to the disclosure, shown in FIG. 1. The adhesive tape 1 according to Example 1 consists of three layers, namely the first layer 5, the second layer 7 and the third layer 9. The first thickness 11 corresponds to 15 μm, the second thickness 13 corresponds to 12 μm and the third thickness 15 corresponds to 105 μm. The first thickness 11, the second thickness 13 and the third thickness 15 result in a ratio of 0.26 ((15+12)/105=0.26). The calculated DuPont impact strength corresponds to 984 mJ. The first layer 5 has the second working example of the electrically releasable adhesive layer of the first layer 5 already described. Example 1 of the adhesive tape 1 can be used in the first embodiment of the assembly 3 according to the disclosure as shown in FIG. 3.

### Example 2

Example 2 of the adhesive tape 1 shown in Table 2 corresponds to the second embodiment of the adhesive tape 1 according to the disclosure, shown in FIG. 2. The adhesive tape 1 according to Example 2 consists of five layers, namely of the first layer 5, two second layers, namely a second layer 7 arranged on a first side of the first layer and a second layer 7 arranged on a second side of the first layer 5, opposite the first side, and two third layers, namely a third layer 9 arranged on the first side of the first layer 5 and a third layer 9 arranged on the second side of the first layer 5. The first thickness 11 corresponds to 10 μm, each second thickness 13 corresponds to 12 μm and each third thickness 15 corresponds to 50 μm. The first thickness 11, the second thicknesses and the third thicknesses result in a ratio of 0.34 ((10+12+12)/(50+50)=0.34). The calculated DuPont impact strength corresponds to 902 mJ. The first layer 5 has the second working example of the electrically releasable adhesive layer of the first layer 5 already described. Example 2 of the adhesive tape 1 can be used in the second embodiment of the assembly 3 according to the disclosure as shown in FIG. 4.

### Example 3

The structure of Example 3 of the adhesive tape 1 shown in Table 2 corresponds to the structure of the first embodiment of the adhesive tape 1 according to the disclosure, shown in FIG. 1. The adhesive tape 1 according to Example 3 consists of three layers, namely the first layer 5, the second layer 7 and the third layer 9. The first thickness 11 corresponds to 30 μm, the second thickness 13 corresponds to 12 μm and the third thickness 15 corresponds to 90 μm. The first thickness 11, the second thickness 13 and the third thickness 15 result in a ratio of 0.47 ((30+12)/90=0.47). The calculated DuPont impact strength corresponds to 767 mJ. The first layer 5 has the second working example of the electrically releasable adhesive layer of the first layer 5 already described. Example 3 of the adhesive tape 1 can be used in the first embodiment of the assembly 3 according to the disclosure as shown in FIG. 3.

### Example 4

The structure of Example 4 of the adhesive tape 1 shown in Table 2 corresponds to the structure of the second embodiment of the adhesive tape 1 according to the disclosure, shown in FIG. 2. The adhesive tape 1 according to Example 4 consists of five layers, namely of the first layer 5, two second layers, namely a second layer 7 arranged on a first side of the first layer 5 and a second layer 7 arranged on a second side of the first layer 5, opposite the first side, and two third layers, namely a third layer 9 arranged on the first side of the first layer 5 and a third layer 9 arranged on the second side of the first layer 5. The first thickness 11 corresponds to 20 μm, each second thickness 13 corresponds to 12 μm and each third thickness 15 corresponds to 45 μm. The first thickness 11, the second thicknesses and the third thicknesses result in a ratio of 0.49 ((20+12+12)/(45+45)=0.49). The calculated DuPont impact strength corresponds to 909 mJ. The first layer 5 has the first working example of the electrically releasable adhesive layer of the first layer 5 already described. Example 4 of the adhesive tape 1 can be used in the second embodiment of the assembly 3 according to the disclosure as shown in FIG. 4.

### Example 5

The structure of Example 5 of the adhesive tape 1 shown in Table 2 corresponds to the structure of the second embodiment of the adhesive tape 1 according to the disclosure, shown in FIG. 2. The adhesive tape 1 according to Example 5 consists of five layers, namely of the first layer 5, two second layers, namely a second layer 7 arranged on a first side of the first layer 5 and a second layer 7 arranged on a second side of the first layer 5, opposite the first side, and two third layers, namely a third layer 9 arranged on the first side of the first layer 5 and a third layer 9 arranged on the second side of the first layer 5. The first thickness 11 corresponds to 30 μm, each second thickness 13 corresponds to 12 μm and each third thickness 15 corresponds to 40 μm. The first thickness 11, the second thicknesses and the third thicknesses result in a ratio of 0.68 ((30+12+12)/(40+40)=0.68). The calculated DuPont impact strength corresponds to 738 mJ. The first layer 5 has the first working example of the electrically releasable adhesive layer of the first layer 5 already described. Example 5 of the adhesive tape 1 can be used in the second embodiment of the assembly 3 according to the disclosure as shown in FIG. 4.

### Example 6

The structure of Example 6 of the adhesive tape 1 shown in Table 2 corresponds to the structure of the second embodiment of the adhesive tape 1 according to the disclosure, shown in FIG. 2. The adhesive tape 1 according to Example 6 consists of five layers, namely of the first layer 5, two second layers, namely a second layer 7 arranged on a first side of the first layer 5 and a second layer 7 arranged on a second side of the first layer 5, opposite the first side, and two third layers, namely a third layer 9 arranged on the first side of the first layer 5 and a third layer 9 arranged on the second side of the first layer 5. The first thickness 11 corresponds to 30 μm, each second thickness 13 corresponds to 12 μm and each third thickness 15 corresponds to 40 μm. The first thickness 11, the second thicknesses and the third thicknesses result in a ratio of 0.68 ((30+12+12)/(40+40)=0.68). The calculated DuPont impact strength corresponds to 768 mJ. The first layer 5 has the third working example of the electrically releasable adhesive layer of the first layer 5 already described. Example 6 of the adhesive tape 1 can be used in the second embodiment of the assembly 3 according to the disclosure as shown in FIG. 4.

### Example 7

The structure of Example 7 of the adhesive tape 1 shown in Table 2 corresponds to the structure of the first embodiment of the adhesive tape 1 according to the disclosure, shown in FIG. 1. The adhesive tape 1 according to Example 7 consists of three layers, namely the first layer 5, the second layer 7 and the third layer 9. The first thickness 11 corresponds to 50 μm, the second thickness 13 corresponds to 12 μm and the third thickness 15 corresponds to 70 μm. The first thickness 11, the second thickness 13 and the third thickness 15 result in a ratio of 0.89 ((50+12)/70=0.89). The calculated DuPont impact strength corresponds to 601 mJ. The first layer 5 has the second working example of the electrically releasable adhesive layer of the first layer 5 already described. Example 7 of the adhesive tape 1 can be used in the first embodiment of the assembly 3 according to the disclosure as shown in FIG. 3.

### Example 8

The structure of Example 8 of the adhesive tape 1 shown in Table 2 corresponds to the structure of the second embodiment of the adhesive tape 1 according to the disclosure, shown in FIG. 2. The adhesive tape 1 according to Example 8 consists of five layers, namely of the first layer 5, two second layers, namely a second layer 7 arranged on a first side of the first layer 5 and a second layer 7 arranged on a second side of the first layer 5, opposite the first side, and two third layers, namely a third layer 9 arranged on the first side of the first layer 5 and a third layer 9 arranged on the second side of the first layer 5. The first thickness 11 corresponds to 40 μm, each second thickness 13 corresponds to 12 μm and each third thickness 15 corresponds to 35 μm. The first thickness 11, the second thicknesses and the third thicknesses result in a ratio of 0.91 ((40+12+12)/(35+35)=0.91). The calculated DuPont impact strength corresponds to 712 mJ. The first layer 5 has the second working example of the electrically releasable adhesive layer of the first layer 5 already described. Example 8 of the adhesive tape 1 can be used in the second embodiment of the assembly 3 according to the disclosure as shown in FIG. 4.

### Example 9

The structure of Example 9 of the adhesive tape 1 shown in Table 2 corresponds to the structure of the second embodiment of the adhesive tape 1 according to the disclosure, shown in FIG. 2. The adhesive tape 1 according to Example 9 consists of five layers, namely of the first layer 5, two second layers, namely a second layer 7 arranged on a first side of the first layer 5 and a second layer 7 arranged on a second side of the first layer 5, opposite the first side, and two third layers, namely a third layer 9 arranged on the first side of the first layer 5 and a third layer 9 arranged on the second side of the first layer 5. The first thickness 11 corresponds to 40 μm, each second thickness 13 corresponds to 12 μm and each third thickness 15 corresponds to 35 μm. The first thickness 11, the second thicknesses and the third thicknesses result in a ratio of 0.91 ((40+12+12)/(35+35)=0.91). The calculated DuPont impact strength corresponds to 651 mJ. The first layer 5 has the first working example of the electrically releasable adhesive layer of the first layer 5 already described. Example 9 of the adhesive tape 1 can be used in the second embodiment of the assembly 3 according to the disclosure as shown in FIG. 4.

### Example 10

The structure of Example 10 of the adhesive tape 1 shown in Table 2 corresponds to the structure of the second embodiment of the adhesive tape 1 according to the disclosure, shown in FIG. 2. The adhesive tape 1 according to Example 10 consists of five layers, namely of the first layer 5, two second layers, namely a second layer 7 arranged on a first side of the first layer 5 and a second layer 7 arranged on a second side of the first layer 5, opposite the first side, and two third layers, namely a third layer 9 arranged on the first side of the first layer 5 and a third layer 9 arranged on the second side of the first layer 5. The first thickness 11 corresponds to 40 μm, each second thickness 13 corresponds to 12 μm and each third thickness 15 corresponds to 35 μm. The first thickness 11, the second thicknesses and the third thicknesses result in a ratio of 0.91 ((40+12+12)/(35+35)=0.91). The calculated DuPont impact strength corresponds to 629 mJ. The first layer 5 has the third working example of the electrically releasable adhesive layer of the first layer 5 already described. Example 10 of the adhesive tape 1 can be used in the second embodiment of the assembly 3 according to the disclosure as shown in FIG. 4.

### Example 11

The structure of Example 11 of the adhesive tape 1 shown in Table 2 corresponds to the structure of the first embodiment of the adhesive tape 1 according to the disclosure, shown in FIG. 1. The adhesive tape 1 according to Example 11 consists of three layers, namely the first layer 5, the second layer 7 and the third layer 9. The first thickness 11 corresponds to 60 μm, the second thickness 13 corresponds to 12 μm and the third thickness 15 corresponds to 60 μm. The first thickness 11, the second thickness 13 and the third thickness 15 result in a ratio of 1.20 ((60+12)/60=1.20). The calculated DuPont impact strength corresponds to 532 mJ. The first layer 5 has the third working example of the electrically releasable adhesive layer of the first layer 5 already described. Example 11 of the adhesive tape 1 can be used in the first embodiment of the assembly 3 according to the disclosure as shown in FIG. 3.

### Example 12

The structure of Example 12 of the adhesive tape 1 shown in Table 2 corresponds to the structure of the first embodiment of the adhesive tape 1 according to the disclosure, shown in FIG. 1. The adhesive tape 1 according to Example 12 consists of three layers, namely the first layer 5, the second layer 7 and the third layer 9. The first thickness 11 corresponds to 60 μm, the second thickness 13 corresponds to 12 μm and the third thickness 15 corresponds to 60 μm. The first thickness 11, the second thickness 13 and the third thickness 15 result in a ratio of 1.20 ((60+12)/60=1.20). The calculated DuPont impact strength corresponds to 521 mJ. The first layer 5 has the second working example of the electrically releasable adhesive layer of the first layer 5 already described. Example 12 of the adhesive tape 1 can be used in the first embodiment of the assembly 3 according to the disclosure as shown in FIG. 3.

### Example 13

The structure of Example 13 of the adhesive tape 1 shown in Table 2 corresponds to the structure of the second embodiment of the adhesive tape 1 according to the disclosure, shown in FIG. 2. The adhesive tape 1 according to Example 13 consists of five layers, namely of the first layer 5, two second layers, namely a second layer 7 arranged on a first side of the first layer 5 and a second layer 7 arranged on a second side of the first layer 5, opposite the first side, and two third layers, namely a third layer 9 arranged on the first side of the first layer 5 and a third layer 9 arranged on the second side of the first layer 5. The first thickness 11 corresponds to 50 μm, each second thickness 13 corresponds to 12 μm and each third thickness 15 corresponds to 30 μm. The first thickness 11, the second thicknesses and the third thicknesses result in a ratio of 1.23 ((50+12+12)/(30+30)=1.23). The calculated DuPont impact strength corresponds to 503 mJ. The first layer 5 has the third working example of the electrically releasable adhesive layer of the first layer 5 already described. Example 13 of the adhesive tape 1 can be used in the second embodiment of the assembly 3 according to the disclosure as shown in FIG. 4.

### Example 14

The structure of Example 14 of the adhesive tape 1 shown in Table 2 corresponds to the structure of the second embodiment of the adhesive tape 1 according to the disclosure, shown in FIG. 2. The adhesive tape 1 according to Example 14 consists of five layers, namely of the first layer 5, two second layers, namely a second layer 7 arranged on a first side of the first layer 5 and a second layer 7 arranged on a second side of the first layer 5, opposite the first side, and two third layers, namely a third layer 9 arranged on the first side of the first layer 5 and a third layer 9 arranged on the second side of the first layer 5. The first thickness 11 corresponds to 50 μm, each second thickness 13 corresponds to 12 μm and each third thickness 15 corresponds to 30 μm. The first thickness 11, the second thicknesses and the third thicknesses result in a ratio of 1.23 ((50+12+12)/(30+30)=1.23). The calculated DuPont impact strength corresponds to 470 mJ. The first layer 5 has the second working example of the electrically releasable adhesive layer of the first layer 5 already described. Example 14 of the adhesive tape 1 can be used in the second embodiment of the assembly 3 according to the disclosure as shown in FIG. 4.

### Example 15

The structure of Example 15 of the adhesive tape 1 shown in Table 2 corresponds to the structure of the second embodiment of the adhesive tape 1 according to the disclosure, shown in FIG. 2. The adhesive tape 1 according to Example 15 consists of five layers, namely of the first layer 5, two second layers, namely a second layer 7 arranged on a first side of the first layer 5 and a second layer 7 arranged on a second side of the first layer 5, opposite the first side, and two third layers, namely a third layer 9 arranged on the first side of the first layer 5 and a third layer 9 arranged on the second side of the first layer 5. The first thickness 11 corresponds to 50 μm, each second thickness 13 corresponds to 12 μm and each third thickness 15 corresponds to 30 μm. The first thickness 11, the second thicknesses and the third thicknesses result in a ratio of 1.23 ((50+12+12)/(30+30)=1.23). The calculated DuPont impact strength corresponds to 521 mJ. The first layer 5 has the first working example of the electrically releasable adhesive layer of the first layer 5 already described. Example 15 of the adhesive tape 1 can be used in the second embodiment of the assembly 3 according to the disclosure as shown in FIG. 4.

### Example 16

The structure of Example 16 of the adhesive tape 1 shown in Table 2 corresponds to the structure of the first embodiment of the adhesive tape 1 according to the disclosure, shown in FIG. 1. The adhesive tape 1 according to Example 16 consists of three layers, namely the first layer 5, the second layer 7 and the third layer 9. The first thickness 11 corresponds to 70 μm, the second thickness 13 corresponds to 12 μm and the third thickness 15 corresponds to 50 μm. The first thickness 11, the second thickness 13 and the third thickness 15 result in a ratio of 1.64 ((70+12)/50=1.64). The calculated DuPont impact strength corresponds to 493 mJ. The first layer 5 has the third working example of the electrically releasable adhesive layer of the first layer 5 already described. Example 16 of the adhesive tape 1 can be used in the first embodiment of the assembly 3 according to the disclosure as shown in FIG. 3.

### Example 17

The structure of Example 17 of the adhesive tape 1 shown in Table 2 corresponds to the structure of the second embodiment of the adhesive tape 1 according to the disclosure, shown in FIG. 2. The adhesive tape 1 according to Example 17 consists of five layers, namely of the first layer 5, two second layers, namely a second layer 7 arranged on a first side of the first layer 5 and a second layer 7 arranged on a second side of the first layer 5, opposite the first side, and two third layers, namely a third layer 9 arranged on the first side of the first layer 5 and a third layer 9 arranged on the second side of the first layer 5. The first thickness 11 corresponds to 60 μm, each second thickness 13 corresponds to 12 μm and each third thickness 15 corresponds to 25 μm. The first thickness 11, the second thicknesses and the third thicknesses result in a ratio of 1.68 ((60+12+12)/(25+25)=1.68). The calculated DuPont impact strength corresponds to 508 mJ. The first layer 5 has the third working example of the electrically releasable adhesive layer of the first layer 5 already described. Example 17 of the adhesive tape 1 can be used in the second embodiment of the assembly 3 according to the disclosure as shown in FIG. 4.

### Example 18

The structure of Example 18 of the adhesive tape 1 shown in Table 2 corresponds to the structure of the second embodiment of the adhesive tape 1 according to the disclosure, shown in FIG. 2. The adhesive tape 1 according to Example 18 consists of five layers, namely of the first layer 5, two second layers, namely a second layer 7 arranged on a first side of the first layer 5 and a second layer 7 arranged on a second side of the first layer 5, opposite the first side, and two third layers, namely a third layer 9 arranged on the first side of the first layer 5 and a third layer 9 arranged on the second side of the first layer 5. The first thickness 11 corresponds to 60 μm, each second thickness 13 corresponds to 12 μm and each third thickness 15 corresponds to 25 μm. The first thickness 11, the second thicknesses and the third thicknesses result in a ratio of 1.68 ((60+12+12)/(25+25)=1.68). The calculated DuPont impact strength corresponds to 502 mJ. The first layer 5 has the first working example of the electrically releasable adhesive layer of the first layer 5 already described. Example 18 of the adhesive tape 1 can be used in the second embodiment of the assembly 3 according to the disclosure as shown in FIG. 4.

### Example 19

The structure of Example 19 of the adhesive tape 1 shown in Table 2 corresponds to the structure of the second embodiment of the adhesive tape 1 according to the disclosure, shown in FIG. 2. The adhesive tape 1 according to Example 19 consists of five layers, namely of the first layer 5, two second layers, namely a second layer 7 arranged on a first side of the first layer 5 and a second layer 7 arranged on a second side of the first layer 5, opposite the first side, and two third layers, namely a third layer 9 arranged on the first side of the first layer 5 and a third layer 9 arranged on the second side of the first layer 5. The first thickness 11 corresponds to 70 μm, each second thickness 13 corresponds to 12 μm and each third thickness 15 corresponds to 20 μm. The first thickness 11, the second thicknesses and the third thicknesses result in a ratio of 2.35 ((70+12+12)/(20+20)=2.35). The calculated DuPont impact strength corresponds to 487 mJ. The first layer 5 has the first working example of the electrically releasable adhesive layer of the first layer 5 already described. Example 19 of the adhesive tape 1 can be used in the second embodiment of the assembly 3 according to the disclosure as shown in FIG. 4.

Examples 1 to 19 of the adhesive tape 1 described were produced by laminating the various layers with a conventional laminating device with heatable rollers. The aluminum-coated side of the carrier material was connected to the electrically detachable adhesive layer here in each case. That is, each second layer 7 was connected by the aluminum-coated side of the electrically conductive carrier layer of the second layer 7 to the electrically releasable adhesive layer of the first layer 5. The lamination of the pressure-sensitive adhesive layers (working examples 1 and 3 of layer 5) took place at room temperature, the lamination of the activatable adhesive layer (working example 2 of layer 5) at 70° C. In this case, the activatable adhesive layer was not activated. Before lamination, adhesive layers and carrier layers were pretreated via corona (dose 40 Ws/m²) in order to improve anchoring on the carrier material.

In connection with the present disclosure, different thicknesses, in particular the first thickness 11, the second thickness 13 and the third thickness 15, are described. The thickness of an adhesive layer, viz. in particular each first thickness 11 and each third thickness 15, is determined by determining the thickness of a portion, defined in terms of its length and width, of the adhesive layer applied to a liner, by first measuring the thickness of the combination of liner and adhesive layer and then subtracting the thickness of the liner from this measured thickness. The thickness of the liner here may be known or is determined separately. The thickness of the adhesive layer can be determined by way of commercially available thickness testers (gauge devices) with accuracies of less than 1 μm deviation. If fluctuations in thickness are detected, the average value of measurements in at least three representative places is reported, i.e. in particular not measured at pinches, folds, specks and the like. As already for the thickness of an adhesive layer, the thickness of an adhesive tape 1 (adhesive strip) and the thickness of a carrier or a carrier material, viz. in particular each second thickness 13, can be determined analogously by way of commercially available thickness testers (gauge devices) with accuracies of less than 1 μm deviation. If fluctuations in thickness are detected, the average value of measurements in at least three representative places is reported, i.e. in particular not measured at pinches, folds, specks and the like.

In connection with the present disclosure, different impact strengths are described. To determine the impact strengths, a square, frame-shaped sample frame with external dimensions of 33 mm×33 mm, a land width of 2.0 mm and internal dimensions (window cut- out) of 29 mm×29 mm is cut out from the adhesive tape 1 to be examined. This sample frame is adhered to a steel frame with external dimensions of 45 mm×45 mm, a land width of 10 mm, internal dimensions (window cut-out) of 25 mm×25 mm and a thickness of 2 mm. On one side of the sample frame opposite the steel frame, the sample frame was bonded to a polycarbonate (PC) window with external dimensions of 35 mm×35 mm and a thickness of 3 mm. The steel frame, the sample frame and the PC window are positioned in such a way that in the bonded state the geometric centers of the steel frame, the sample frame and the PC window and the diagonals of these components are superimposed (center to center). In the bonded state, the combination of steel frame, sample frame and PC window can also be referred to as the bond. The bond areas are thus 248 mm² in each case. The combination of steel frame, sample frame and PC window is pressed at room temperature for 5 s with a pressure of 1 MPa and stored for 24 hours at 23° C./50% relative humidity. In addition, in the electrically releasable adhesive layer of the first layer 5 according to the second working example of the electrically releasable adhesive layer of the first layer 5, the combination of steel frame, sample frame and PC window was pressed and activated at 100° C. for 5 min under a pressure of 1 MPa. The combination of steel frame, sample frame and PC window is then clamped by the protruding edges of the steel frame into a sample holder in such a way that the combination of steel frame, sample frame and PC window is aligned horizontally.

Here, the steel frame rests flat at the protruding edges on the sample holder such that the PC window is free-floating (held by the adhesive tape specimen) beneath the steel frame. The sample holder is then inserted centrally into the intended receptacle of the “DuPont Impact Tester”. The impact head of weight 150 g is inserted in such a way that the circular impact geometry with a diameter of 24 mm lies centrically and flush on the face of the PC window that is freely accessible from above. A weight having a mass of 150 g guided on two guide rods is dropped vertically from a height of 5 cm onto the combination of steel frame, sample frame and PC window thus arranged (measurement conditions 23° C., 50% relative humidity). The height from which the weight is dropped is increased in 5 cm steps until the impact energy introduced destroys the sample as a result of the penetration load and the PC window parts from the steel frame. The impact strength is then determined as follows and the energy is calculated as follows: energy E [J]=height [m]*weight [kg]*9.81 kg/m*s². For each example of the adhesive tape 1 shown in Table 2, five samples were tested, and the average energy value was reported as an indicator of the dielectric strength.

In connection with the present disclosure, reference is made to peel adhesion forces. The peel adhesion forces were determined in analogy to ISO 29862 (Method 3) at 23° C. and 50% relative humidity at a peeling speed of 300 mm/min and a peel angle of 180°. An etched PET film 50 μm in thickness as is obtainable from Coveme (Italy) was used as reinforcing film. In the case of adhesive tapes according to FIG. 1 (first embodiment of the adhesive tape according to the disclosure), the electrically releasable adhesive layer was laminated onto the steel plate. When using the activatable adhesive layer, that is, the electrically releasable adhesive layer of the first layer 5 according to the second working example of the electrically releasable adhesive layer of the first layer 5 in the structure, said layer, if present as an outer layer, was laminated at a temperature of 70° C. onto the steel plate. In each case, the activatable adhesive layer, that is, the electrically releasable adhesive layer of the first layer 5 according to the second working example of the electrically releasable adhesive layer of the first layer 5, was activated at 100° C. for 5 min under a pressure of 1 MPa in an autoclave. Steel plates according to the standard were used as substrate. The measurement strip was bonded here using a roll-on machine at 4 kg at a temperature of 23° C. The adhesive tapes were peeled off immediately after application or after the electrical release process. The measured value (in N/cm) was the mean value of three individual measurements.

The electrical releasability of the electrically releasable adhesive layer was verified as follows. For each example shown in Table 2, an adhesive tape 1, which can also be referred to as reference adhesive tape in each case, with a bond width of 24 mm, was produced.

Each reference adhesive tape was produced in the same way as the corresponding example of the adhesive tape 1 shown in Table 2, with each reference adhesive tape having each second layer 7 protruding laterally around 4 cm over the first layer 5 and each third layer 9, so that each electrically conductive carrier layer protrudes laterally around 4 cm over the first layer 5 and each third layer 9. In the case of a structure as shown in FIG. 1, the first layer 5 was laminated onto a steel plate according to ISO 29862. When using the activatable second working example of the layer 5 in an adhesive tape 1 according to FIG. 1, the lamination was carried out at a temperature of 70° C. in a hot laminator. When using the activatable second working example of the layer 5 in an adhesive tape 1 according to FIG. 1 or FIG. 2, an activation at 100° C. for 5 min at a pressure of 1 MPa took place in an autoclave after lamination. An electrical voltage was then applied to the electrically releasable adhesive layer by attaching a first alligator clip (jaws insulated with rubber on the outside) with a positive pole to a protruding region of the second layer 7 and attaching a second alligator clip (jaws insulated with rubber on the outside) with a negative pole to the steel plate, or attaching the first alligator clip (jaws insulated with rubber on the outside) with the positive pole to the protruding region of the second layer 7 and attaching a second alligator clip (jaws insulated with rubber on the outside) with a negative pole to a protruding region of another second layer 7. The electrical voltage here was 12 volts and was applied for 1 minute. After 1 minute had elapsed, the electrical voltage was removed and immediately afterwards the peel adhesion was determined according to the method already described. All adhesive tapes having the first layer 5 with the electrically releasable adhesive layer had a peel adhesion of below 0.5 N/cm after application of the electrical voltage and so were electrically releasable. The steel plate showed no residues in the corresponding test specimens. Before application of the electrical voltage, all adhesive tapes with the electrically releasable first layer 5 had a peel adhesion of 3.2 to 6.8 N/cm.

In connection with the present disclosure, reference is made to the storage modulus. The storage modulus for adhesives is determined in an oscillating shear experiment (dynamic mechanical analysis, DMA) under torsional load at a temperature of 23° C. and a frequency of 1 l/s. The test is used to investigate rheological properties and is described in detail in ISO 6721-10. It is run in a shear-rate-controlled rheometer under torsional load, using a plate/plate geometry with a plate diameter of 25 mm.

The following considerations support the advantage achieved by the present disclosure, namely that when the ratio of the sum of the first thickness and each second thickness to the sum of each third thickness is equal to or less than 1.0, the impact strength of the adhesive tape can be influenced particularly well by changing the ratio.

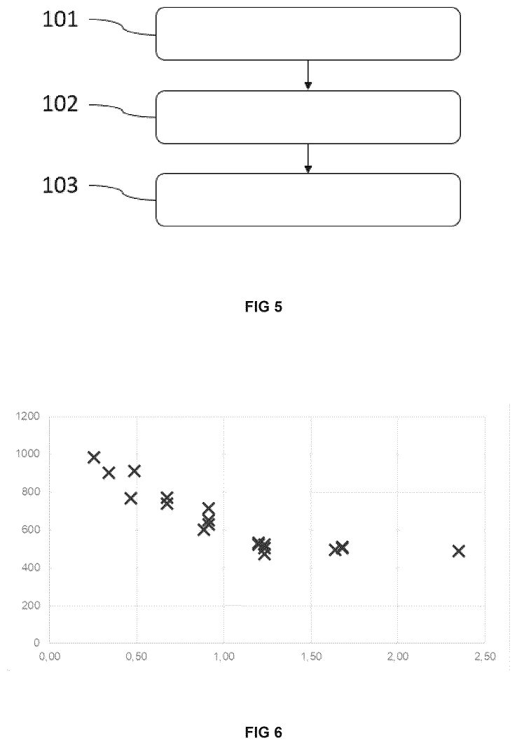

As already described, FIG. 6 shows the scatter diagram, in which the impact strength is plotted against the ratio for different examples of adhesive tapes. The examples correspond to the examples shown in Table 2. The scatter diagram shows that at smaller ratios, a change in the ratio causes a large change in the impact strength, and that at larger ratios, a change in the ratio does not cause a large change in the impact strength.

Although the method steps are described in one certain order, the present disclosure is not limited to this order. Rather, the individual method steps can be carried out in any meaningful order, including in particular at least in portions temporally in parallel with each other.

In addition, it should be noted that “having” or “comprising” does not exclude any different elements or steps and “a” or “one” does not exclude any multiplicity. It should also be noted that features described with reference to one of the above working examples may also be used in combination with other features of other working examples described above. Reference signs in the claims are not to be regarded as a restriction.

According to a first aspect of the present disclosure, an adhesive tape comprises: a plurality of interconnected layers comprising: (a) a first layer that is an electrically releasable adhesive layer comprising a first thickness measured perpendicular to an extent plane of the first layer; (b) at least one second layer, each of which is an electrically conductive carrier layer and comprises a second thickness measured perpendicular to an extent plane of the corresponding second layer; and (c) at least one third layer, each of which is an adhesive layer and comprises a third thickness measured perpendicular to an extent plane of the corresponding third layer, wherein, a ratio of a sum of the first thickness and each second thickness to a sum of each third thickness is equal to or less than 1.0.

According to a second aspect of the present disclosure, the adhesive tape of the first aspect is presented, wherein the ratio is greater than 0.1.

According to a third aspect of the present disclosure, the adhesive tape of any of the first through second aspects is presented, wherein the plurality of interconnected layers consists of the first layer, a second layer, and a third layer.

According to a fourth aspect of the present disclosure, the adhesive tape of any of the first through third aspects is presented, wherein the plurality of interconnected layers consists of the first layer, two second layers, and two third layers.

According to a fifth aspect of the present disclosure, the adhesive tape of any of the first through fourth aspects is presented, wherein the first layer comprises an electrolyte.

According to a sixth aspect of the present disclosure, the adhesive tape of the fifth aspect is presented, wherein the electrolyte is an ionic liquid or a metal salt.

According to a seventh aspect of the present disclosure, the adhesive tape of any one of the first through sixth aspects is presented, wherein the first layer comprises a heat-activatable adhesive.

According to an eighth aspect of the present disclosure, the adhesive tape of any one of the first through seventh aspects is presented, wherein each of the at least one third layer is not electrically releasable.

According to a ninth aspect of the present disclosure, the adhesive tape of any one of the first through eighth aspects is presented, wherein each of the at least one third layer is foamed.

According to a tenth aspect of the present disclosure, the adhesive tape of any one of the first through ninth aspects is presented, wherein (i) the first thickness is within a range of from 10 μm to 50 μm, and (ii) the sum of each third thickness is within a range of from 70 μm to 105 μm.

According to an eleventh aspect of the present disclosure, the adhesive tape of any one of the first through tenth aspects is presented, wherein the adhesive tape exhibits a DuPont Impact Strength that is within a range of from 601 mJ to 984 mJ.

According to a twelfth aspect of the present disclosure, the adhesive tape of any one of the first through eleventh aspects is presented, wherein the first layer comprises a pressure sensitive acrylate adhesive and an electrolyte dispersed therein.

According to a thirteenth aspect of the present disclosure, the adhesive tape of the twelfth aspect is presented, wherein the first layer further comprises microballoons dispersed therein.

According to a fourteenth aspect of the present disclosure, the adhesive tape of the thirteenth aspect is presented, wherein the first layer comprises a polyurethane-based heat-activable adhesive and an electrolyte dispersed therein.

According to a fifteenth aspect of the present disclosure, the adhesive tape of any one of the first through fourteenth aspect is presented, wherein each of the at least one second layer comprises a polymer film coated with a metal on one side thereof.

According to a sixteenth aspect of the present disclosure, the adhesive tape of any one of the first through fifteenth aspect is presented, wherein the third layer comprises a pressure sensitive acrylate adhesive and microballoons dispersed therein.

According to a seventeenth aspect of the present disclosure, an assembly comprises: a first substrate connected to the first layer of the adhesive tape of the third aspect; and a second substrate connected to the third layer of the adhesive tape of the third aspect.

According to an eighteenth aspect of the present disclosure, an assembly comprises a first substrate connected to one of the two third layers of the adhesive tape of the fourth aspect; and a second substrate connected to the other of the two third layers of the adhesive tape of the fourth aspect.

According to a nineteenth aspect of the present disclosure, a method for electrically releasing the assembly of the seventeenth aspect, the method comprising: (a) contacting a first portion of the assembly with a first portion of a voltage source; (b) contacting a second portion of the assembly with a second portion of the voltage source; and (c) providing an electrical voltage using the voltage source, so that the electrical voltage is applied between the first portion of the assembly and the second portion of the assembly.

According to a twentieth aspect of the present disclosure, a method for electrically releasing the assembly of the eighteenth aspect, the method comprising: (a) contacting a first portion of the assembly with a first portion of a voltage source; (b) contacting a second portion of the assembly with a second portion of the voltage source; and (c) providing an electrical voltage using the voltage source, so that the electrical voltage is applied between the first portion of the assembly and the second portion of the assembly.

What is claimed is:

1. An adhesive tape comprising:
a plurality of interconnected layers comprising:
a first layer that is an electrically releasable adhesive layer comprising a first thickness measured perpendicular to an extent plane of the first layer;
at least one second layer, each of which is an electrically conductive carrier layer and comprises a second thickness measured perpendicular to an extent plane of the corresponding second layer; and
at least one third layer, each of which is an adhesive layer and comprises a third thickness measured perpendicular to an extent plane of the corresponding third layer,
wherein, a ratio of a sum of the first thickness and each second thickness to a sum of each third thickness is equal to or less than 1.0.

2. The adhesive tape of claim 1, wherein the ratio is greater than 0.1.

3. The adhesive tape of claim 1, wherein the plurality of interconnected layers consists of the first layer, a second layer, and a third layer.

4. The adhesive tape of claim 1, wherein the plurality of interconnected layers consists of the first layer, two second layers, and two third layers.

5. The adhesive tape of claim 1, wherein the first layer comprises an electrolyte.

6. The adhesive tape of claim 5, wherein the electrolyte is an ionic liquid or a metal salt.

7. The adhesive tape of claim 1, wherein the first layer comprises a heat-activatable adhesive.

8. The adhesive tape of claim 1, wherein each of the at least one third layer is not electrically releasable.

9. The adhesive tape of claim 1, wherein each of the at least one third layer is foamed.

10. The adhesive tape of claim 1, wherein
the first thickness is within a range of from 10 μm to 50 μm, and
the sum of each third thickness is within a range of from 70 μm to 105 μm.

11. The adhesive tape of claim 1, wherein
the adhesive tape exhibits a DuPont Impact Strength that is within a range of from 601 mJ to 984 mJ.

12. The adhesive tape of claim 1, wherein
the first layer comprises a pressure sensitive acrylate adhesive and an electrolyte dispersed therein.

13. The adhesive tape of claim 12, wherein
the first layer further comprises microballoons dispersed therein.

14. The adhesive tape of claim 1, wherein
the first layer comprises a polyurethane-based heat-activable adhesive and an electrolyte dispersed therein.

15. The adhesive tape of claim 1, wherein
each of the at least one second layer comprises a polymer film coated with a metal on one side thereof.

16. The adhesive tape of claim 1, wherein
the third layer comprises a pressure sensitive acrylate adhesive and microballoons dispersed therein.

17. An assembly comprising:
a first substrate connected to the first layer of the adhesive tape of claim 3; and
a second substrate connected to the third layer of the adhesive tape of claim 3.

18. An assembly comprising:
a first substrate connected to one of the two third layers of the adhesive tape of claim 4; and
a second substrate connected to the other of the two third layers of the adhesive tape of claim 4.

19. A method for electrically releasing the assembly of claim 17, the method comprising:
contacting a first portion of the assembly with a first portion of a voltage source;
contacting a second portion of the assembly with a second portion of the voltage source; and
providing an electrical voltage using the voltage source, so that the electrical voltage is applied between the first portion of the assembly and the second portion of the assembly.

20. A method for electrically releasing the assembly of claim 18, the method comprising:
contacting a first portion of the assembly with a first portion of a voltage source;
contacting a second portion of the assembly with a second portion of the voltage source; and
providing an electrical voltage using the voltage source, so that the electrical voltage is applied between the first portion of the assembly and the second portion of the assembly.
